(19) United States
(12) Patent Application Publication
(10) Pub. No.: US 2025/0119913 A1
(43) Pub. Date: Apr. 10, 2025

(54) METHODS AND APPARATUS FOR SUPPORTING FEDERATED MACHINE LEARNING OPERATIONS IN A COMMUNICATION NETWORK

(71) Applicant: InterDigital Patent Holdings, Inc., Wilmington, DE (US)

(72) Inventors: Morteza Kheirkhah, London (GB); Alec Brusilovsky, Downingtown, PA (US); Ulises Olvera-Hernandez, Saint-Lazare (CA); Samir Ferdi, Kirkland (CA); Guanzhou Wang, Brossard (CA); Zhibi Wang, Woodridge, IL (US)

(73) Assignee: InterDigital Patent Holdings, Inc., Wilmington, DE (US)

(21) Appl. No.: 18/730,065

(22) PCT Filed: Jan. 25, 2023
(86) PCT No.: PCT/US2023/011506

§ 371 Date: Jul. 18, 2024

Related U.S. Application Data
(60) Provisional application No. 63/303,693, filed on Jan. 27, 2022.
(60) Provisional application No. 63/338,694, filed on May 5, 2022.

(51) Int. Cl. H04W 72/20; H04L 43/0852; H04W 72/51; H04W 76/20

(52) U.S. Cl. CPC H04W 72/20; H04L 43/0858; H04W 72/51; H04W 76/20

(57) ABSTRACT

A method implemented in a Wireless Transmit Receive Unit (WTRU) for controlling resource usage associated with delivery of training results for a machine learning (ML) operation includes receiving one-way packet delay measurements between the WTRU and an Application Server or Application Function (AS/AF), predicting one or more upcoming one-way packet delays using the one-way packet delay measurements, determining whether the WTRU is capable of processing and delivering training results of the ML operation to the AS/AF within a specified time period based on the predicted upcoming one-way packet delays, and initiating one of a packet data unit session (PDU) release procedure or a PDU session modification procedure.

### CROSS REFERENCE TO RELATED APPLICATIONS

This application claims the benefit of US provisional patent application Nos. 63/303,693 filed on 27 Jan. 2022 and 63/338,694 filed on 5 May 2022, each of which is incorporated herein by reference.

### TECHNICAL FIELD

This disclosure pertains to methods and apparatus for optimizing network resource utilization in connection with federated machine learning operations in a communication network.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a block diagram of a WTRU architecture for supporting AI/ML;

FIG. 3 is a signal flow diagram illustrating signal flow interactions between various components of a WTRU and a network;

FIGS. 4A and 4B depict an example service flow for network services exposure for a WTRU with a subscribe/notify construct;

FIG. 5 depicts an example service flow for network services exposure to a WTRU with a request/response;

FIG. 6 depicts an example service flow of a WTRU terminating network exposure subscription; and

FIG. 7 depicts an example flow diagram describing a method of a WTRU to control resource usage.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

### Example Communication Systems

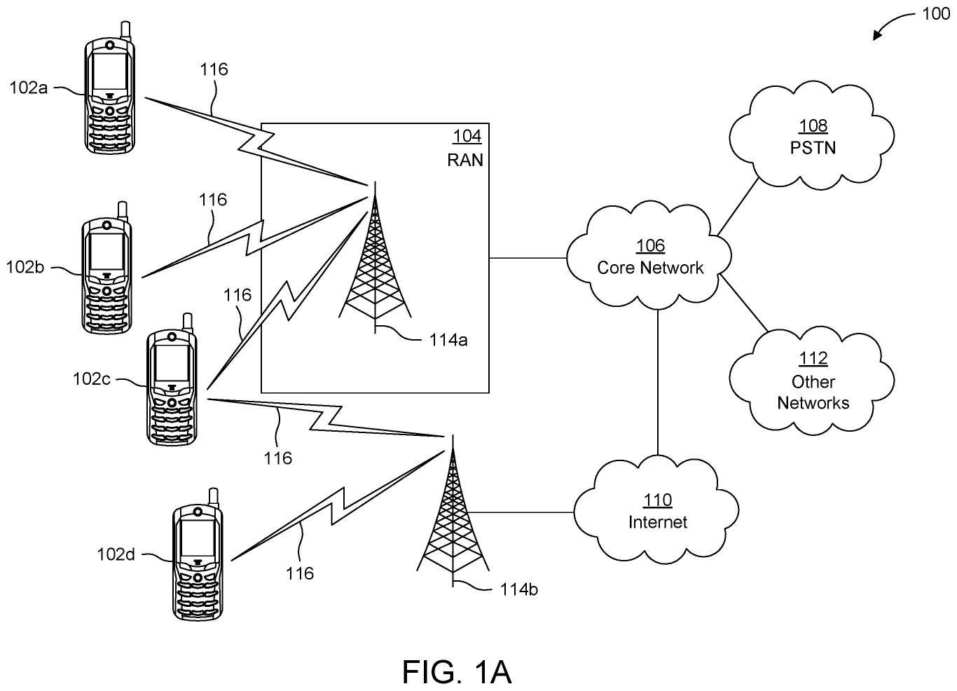

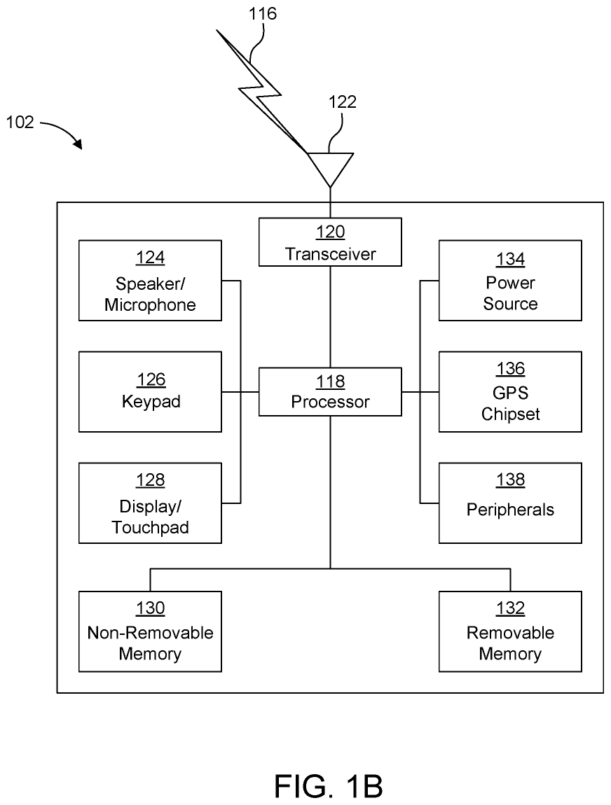

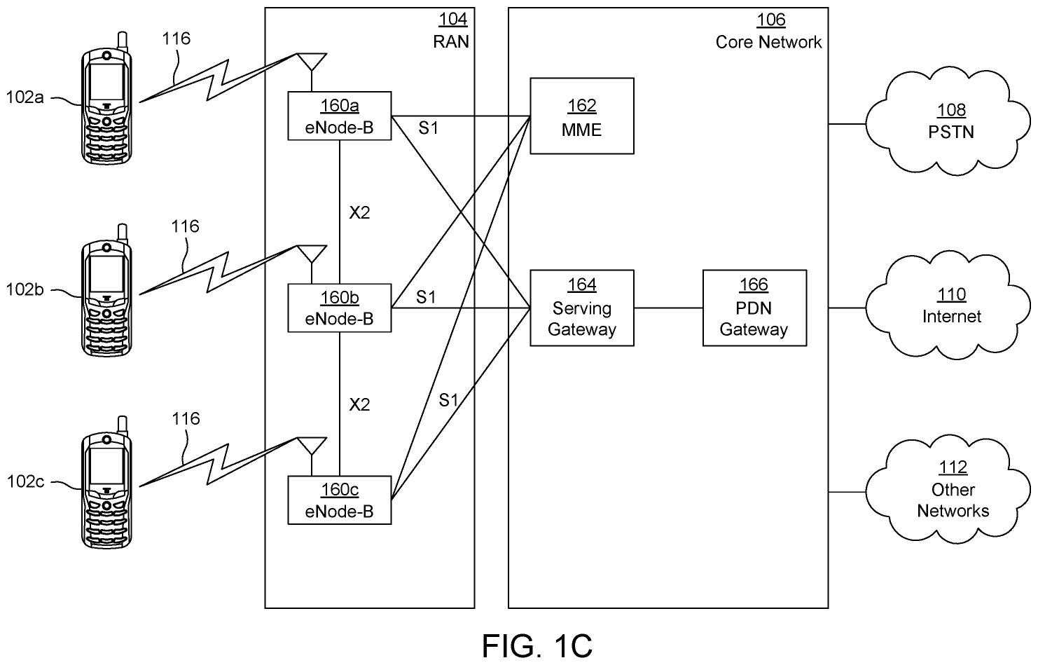

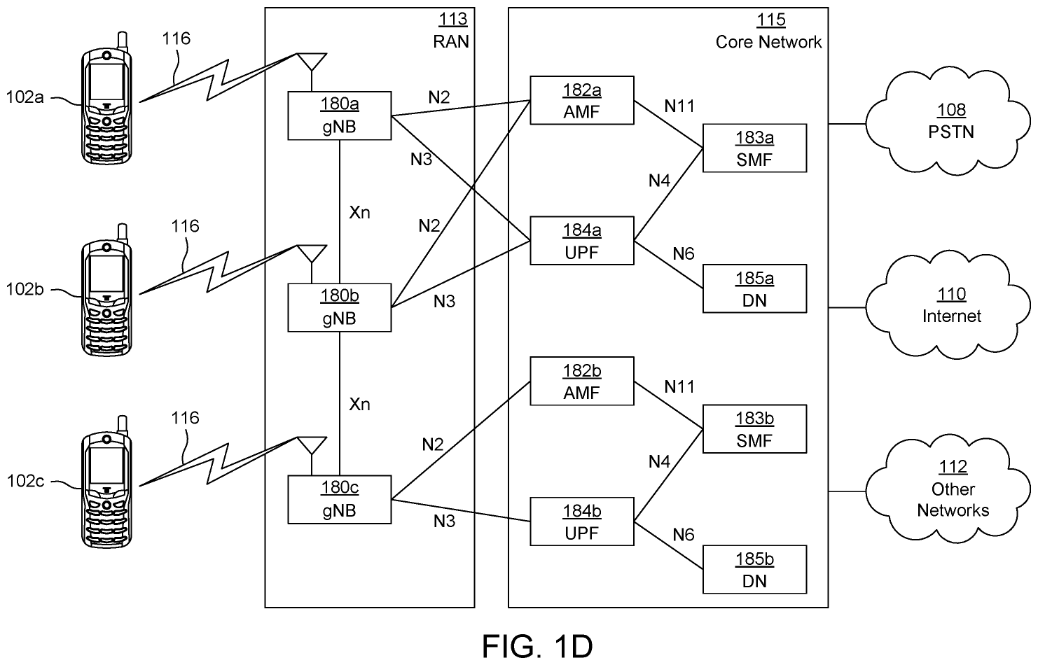

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11 ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11 ah. The channel operating bandwidths, and carriers, are reduced in 802.11 af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11 ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11 ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11 ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one User Plane Function (UPF) 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different Packet Data Unit (PDU) sessions with different requirements), selecting a particular Session Management Function (SMF) 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF a82a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Examples provided herein do not limit applicability of the subject matter to other wireless technologies, e.g., using the same or different principles as may be applicable.

As explained herein, a wireless transmit/receive unit (WTRU) may be an example of a user equipment (UE). Hence the terms UE and WTRU may be used with equal scope herein.

### Federated Machine Learning Operations in a Communication Network

### Aspects of Federated Machine Learning Operations

Federated Learning (FL) is a machine learning technique that trains an algorithm across multiple decentralized edge devices or servers holding local data samples, without exchanging the samples. Federated learning allows a plurality of users to build a machine learning model without sharing data.

Handling Federated Learning (FL) traffic, especially for those applications engaged in machine learning (ML) model training, creates new challenges to 3GPP systems due to some unique characteristics and behaviors of FL. Two key factors contribute to these challenges. Firstly, the FL traffic is unusually bursty; a burst of traffic may come from a large number of WTRUs transmitting a large amount of data simultaneously toward an Application Server (AS) responsible for training a global machine learning model and/or an AS sending a large volume of data toward a set of WTRUs. Secondly, the FL flows have a deadline for their flow completion time (FCT). This means that if a WTRU and/or AS fails to deliver its flows within a specific time window, its tasks computation (more specifically, its new trained model) will not be used, and consequently, all the resources used by the 3GPP system to transfer the trained model to the AS would have been wasted. Further, the computational resources at the WTRU (e.g., Graphics Processing Unit/Central Processing Unit (GPU/CPU)) would also have been wasted, which may have a direct impact on WTRU's battery status. Examples of these resources include:
a. Computational resources. This includes the WTRU's and AS's GPU and CPU resources.
b. Radio resources. This includes air interface resources at both the WTRU and RAN. This also has direct implications on a WTRU's energy consumption and, in turn, battery life.
c. Network resources. This includes the 3GPP's core network resources, which comprise user plane and control plane resources that need to be used to support FL traffic.
d. WTRU's energy resources. Any operations at a WTRU require power consumption, in particular data processing and radio operations. Using these resources exceedingly could acutely reduce the battery life.

Thus, it would be beneficial to allow the 3GPP system, including a WTRU and the Core Network (CN), to proactively enable resources to handle Artificial Intelligence/Machine Learning (AI/ML) traffic and that can support FL and its variants (e.g., synchronized FL) in order to prevent AI/ML applications from missing their task/flow completion deadlines.

Further, it would be beneficial for the 3GPP entities to inform an AS (or Application Function (AF) serving the WTRU) and/or the WTRU of the availability of the 3GPP resources (e.g., at the WTRU and CN), which might enable the AF/AS and/or WTRU to predict when an AI/ML's flow is going to miss the deadline. When such a condition is detected, the 3GPP entities (e.g., WTRU and CN) and AF/AS can take appropriate action to prevent wasting resources performing a task that will not be completed or useful.

Yet further, it would be beneficial to provide information and knowledge that the 3GPP system (more specifically WTRU) could use to assist AI/ML application servers in making a more informed selection of the next set of WTRUs for the next cycle of model training.

In addition, there are currently no known 3GPP mechanism that would enable the WTRU to access Network Exposure Services (NES), e.g., by subscribing to notification events from 3GPP Network Functions. Furthermore, any mechanism envisioned to enable this functionality would need to ensure that a WTRU application securely receive and request data from the core network. For example, when a WTRU requests (e.g. location information of another WTRU (e.g., a target WTRU) from the location server, or when the WTRU wants to request data analytics from the Network Data Analytics Function (NWDAF).
a. Control Plane Considerations: Although there are known solutions that enable the WTRU to access network services using non-access stratum (NAS) as a secure transport, these solutions don't address how authorization is enforced and how the end-to-end security between the WTRU and network function (NF) should be addressed.
b. User Plane (UP) Considerations: If the WTRU were allowed to request access to Network Exposure Functionality without additional authorization and security measures, the existing User Plane (UP) security between WTRU and gNB only provides hop by hop encryption and integrity protection to the user traffic, which is insufficient to provide the security to protect the core network (CN) from being attacked by a malicious WTRU that directly sends the network exposure requests to the Network Function (NF) in the core network. In addition, there is no authorization that is enabled using the current mechanism for traffics between a WTRU via UPF to the NF. In other words, the core network should be protected when the network capability is exposed to applications in WTRU.

### Signalling Delay Estimates to the WTRU

New ways are presented for providing a WTRU with an accurate estimate of packet delays within the 3GPP system, particularly an estimate of packet delay between a WTRU, RAN, and UPF. With current 3GPP standards, it is possible to estimate these delays at the UPF provided that DL/UL PDU Session Information signaling messages are activated between the UPF and RAN [5]. Similar packet delay measurements are also available at the Time Sensitive Communications Assistance Container (TSCSF) in the case of Time Sensitive Communications (TSC). However, the WTRUs are unaware of such information. Having such information at the WTRU is crucial for determining whether the WTRU can meet the deadline of FL tasks/flows. If the WTRU cannot meet its deadline, it is better to terminate the ongoing training activities, thereby preventing 3GPP resources associated with corresponding PDU Sessions from being wasted. Additionally, terminating the ongoing model training also would save GPU/CPU cycles and, in turn, WTRU energy resources. To this end, it would be beneficial to provide such information to the WTRU on a regular basis.

A viable way to signal these packet delay estimations to a WTRU is to first signal these delay estimates from the UPF to the SMF over the N4 interface. After that, the SMF can use a NAS message to deliver these measurements to the WTRU (over the N1 interface), passing transparently through the AMF and RAN.

### Delay Prediction at the WTRU

A new Machine Learning (ML) based component at the WTRU (herein termed the Delay Predictor (DP)) is disclosed herein that accurately predicts packet delays bidirectionally between the WTRU and RAN, RAN, and CN, CN and AS, and WTRU and AS.

### Predictor Engine Architecture

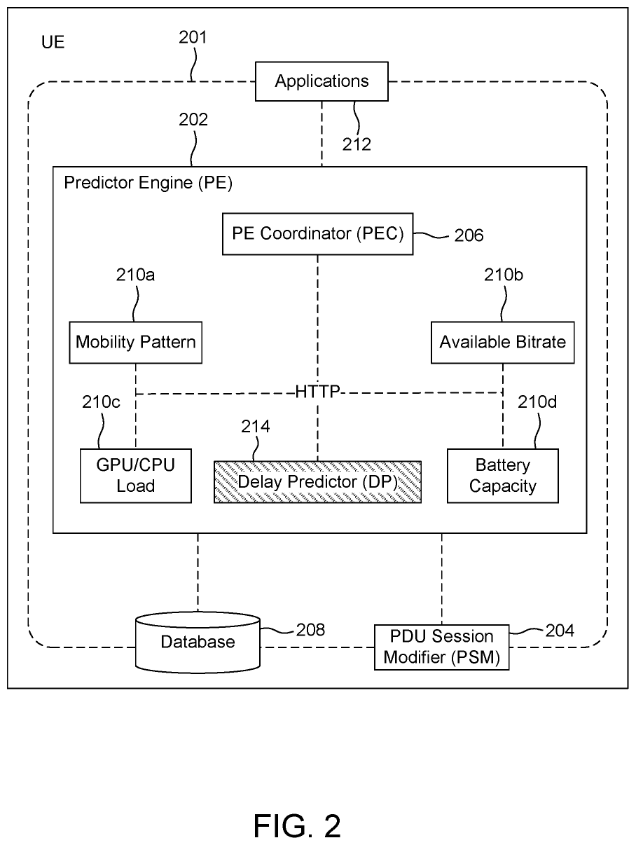

FIG. 2 depicts an architecture including a Predictor Engine (PE) 202 to be described herein. The architecture is inspired to address challenges involved with FL workloads. Additionally, the new components in the FIG. 2 architecture can also be used for other applications with dynamic QoS/resource management requirements.

### WTRU Architecture for Supporting AI/ML

The FIG. 2 block diagram architecture aims to exploit state-of-the-art AI/ML techniques at its core in a unified manner to assist applications 212 by providing diverse, intelligent predictions. This architecture proposes a new layer 202 called the “Predictor Engine” (PE) which hosts several intelligent, potentially ML-based, components to produce important predictions within the WTRU such as available bitrate/capacity, GPU/CPU availability, battery life, and user mobility.

This layer may be built on top of a virtualized platform such as a Docker platform (an OS-level virtualization platform), where each predictor module may be run in an isolated container comprising customized software packages, libraries, and operating systems. This is important for AI/ML-based techniques that typically operate within a specific platform with a particular set of libraries, software packages, and operating systems. Other components in this architecture are a PDU Session Modifier (PSM) 204, a Predictor Engine Coordinator (PEC) 206, and a database 208 that may also be used similarly in a virtualized environment (e.g., in a Docker container) interacting with applications, PE modules, and external entities outside the WTRU (e.g., NWDAF in 5GC, AF, or other WTRUs in the case of Sidelink communication, e.g. PC5 interface).

This architecture preserves WTRU privacy, preventing the WTRU from providing its row data (personal data) to the third party to produce such predictions. These predictions may be used within the WTRU, Application Function (AF) serving the WTRU, Application Server (AS), and 3GPP entities (e.g., RAN and CN) to optimize various resources (e.g., network, computational, and storage). Specifically, the proposed PE layer may assist the 3GPP system in optimizing its resources by dynamically managing PDU Sessions via the PSM component. All communication between these components is through RESTful APIs over, e.g., hyper text transport protocol (HTTP)/2 [1] connection (the dotted lines in FIG. 2).

### Predictor Engine

The Predictor Engine (PE) 202 may be an AI engine in which multiple Machine Learning (ML) modules 210 a-d (e.g. modules including mobility pattern 210a, available bitrate 210b, GPU/CPU load 210c, and battery capacity 210d) may run in parallel to produce a set of predictions. Each box in the PE layer 202 in FIG. 2 may be an ML module producing a particular prediction. For example, prediction of GPU/CPU usage, prediction of battery life, prediction of available bitrate/capacity, prediction of WTRU's mobility, to only name a few. Each ML module may collect row data/measurements/statistics from the WTRU across its multiple components including applications and even other ML modules. The latter creates an instance of a multi-agent ML scenario where an output of an ML module is used as an input to another ML module. For example, the prediction of WTRU mobility can be used as a state input for the bitrate predictor module, or the output of the bitrate predictor module can be inputted to the GPU/CPU predictor module.

The communication between the predictor modules 210 as well as all the other components in FIG. 2 may be performed over the HTTP/2 protocol (with RESTful APIs). Communication over HTTP/2 with RESTful APIs provides several benefits, including:
(i) new (ML-based) modules may be designed and easily integrated into the PE engine and may interact with existing PE modules over standard APIs;
(ii) the PE engine may communicate with other entities outside the WTRU (e.g., 5GS, specifically 5GC which similarly follows a service-based architecture), offering its services to outside consumers. For example, the PE may receive network data and analytics from the 5GC through NWDAF, or the NWDAF operating in 5GC may receive some predictions regarding the WTRU from the PE engine. These interactions may be performed over the control plane (through Non-Access Stratum (NAS) signaling [4]);
(iii) communication over HTTP may be highly secure with well-known encryption techniques that are widely used today (e.g., via transport layer security (TLS)); and
(iv) resources may be used efficiently at the WTRU due to the stateless nature of RESTful APIs, i.e., service producers (e.g., PE modules) at the WTRU do not need to keep their client's state.

The internal communications between the PE modules and other modules running at the WTRU may be performed over an unsecured connection to save some compute resources, but it may be preferable to perform external communication more securely.

PE modules may directly feed their predictions to applications, local databases, and other local modules, such as PSM. It is worth highlighting that the PE component could use an orchestration mechanism to manage its containers (or virtual machines) dynamically (e.g., Docker, Kubernetes).

The PE Coordinator (PEC) 206 is introduced in the PE layer 202 to interface with entities operating outside the PE layer, such as applications 212, databases 208, PSM 204 (see FIG. 2). These interactions may be performed via HTTP. In addition, the PEC may interact with entities outside the WTRU, such as those in the 5GC. The PEC may interact with the 5GC (e.g., AMF, SMF, NWDAF or other NFs) through NAS signaling. Overall, the core concern of PEC is to permit data/predictions/measurements to be exchanged between the WTRU components as well as between the WTRU and external entities optimally. This module should also interact closely with the container/virtual machine (VM) orchestration component.

The PE may also include a virtualized network function responsible for keeping track of what the PE modules are onboarded and their statuses, e.g., whether they are activated or not. This could be similar to the Network Repository Function (NRF) in 5GC or, more generally, to the Virtual Network Function (VNF) catalogue or a container repository as part of the Docker platform.

### PDU Session Modifier (PSM)

The primary responsibility of the PDU Session Modifier (PSM) 204 is to modify PDU Sessions on behalf of applications dynamically. The PSM operates at the application layer and interfaces with the NAS layer to modify PDU Sessions initially established by applications. An application expresses its requirements to the PSM (e.g., bandwidth, latency, reliability, availability, task completion deadlines) and the PSM then decides what predictions are required for its decision-making to satisfy such requirements. After that, the PSM activates a set of PE modules (if they are inactive) and subscribes to them to get event notifications when required predictions (or events) become available. The PSM 204 may either directly interact with the PE modules 210a-d or via the PEC 206. The PSM 204 feeds these predictions to its optimization algorithms to modify corresponding PDU Sessions to meet the requirements of applications and to optimize WTRU resources dynamically. Such functionality is important for resource optimization, especially with applications that exhibit highly dynamic workflows.

The decision by the PSM 204 to select a set of forecasts may be skipped when an application directly expresses its required predictions to the PSM, which could be at the initial registration time to the PSM or any time during the application lifetime.

The PSM 204 provides several key benefits. Firstly, applications do not need to deal with low-level interactions with the NAS layer. Secondly, applications do not need to know how to interact with the PE modules. That said, applications may prefer to interact with the PE modules either directly or via the PEC 206 to get some predictions for optimizing their behavior regardless of PSM optimizations. Thirdly, the number of PE modules can increase over time in a WTRU or be different in different WTRUs. Thus, to satisfy a particular application's needs, a set of predictions available at a WTRU may be dynamically selected by the PSM 204, and applications 212 do not need to know which predictions/modules are used for modifying their PDU Sessions. In other words, the PSM module may only need to be fully aware of PE modules 210a-d, not applications 212. This condition may become more relaxed if the PSM 204 interacts with the PE modules 210 via the PEC 206. In that case, the PEC 206 only needs to be aware of the PE modules 210. It is worth highlighting that the mapping between application requirements and predictions may be enforced by a set of standardized policies and rules.

The main goal of the PSM is to prevent resources (e.g., network, radio, computation, storage, and energy) of the WTRU as well as the 3GPP system (including RAN and CN) from being wasted. The following are some tasks that the PSM may perform dynamically:
(i) initiate a PDU Session Modification procedure to increase or decrease resources available to application traffic;
(ii) change the application traffic priority within a PDU Session dynamically;
(iii) switch User Plane Function (UPF) if the WTRU has multiple active PDU Sessions toward different UPFs, which is a common scenario with Edge Application Servers (EASs);
(iv) tear down or reactivate a PDU Session;
(v) stop/pause applications from continuing their current tasks (e.g., in case they cannot meet the requirements of their applications).

The PSM may interact with the 5GC (e.g., NWDAF, AF, or other NFs) via the PEC component and, in turn, partly over the NAS signaling. This way, the PEC 206 may exchange information (e.g., data, predictions, analytics, measurements) between the WTRU and the 5GC on behalf of the PSM 204. The PSM component may also interact with the 5GC via the NAS layer (more specifically over non-access stratum session management (NAS-SM) signaling, which terminates at the SMF; for a more detailed discussion, see “Signalling Delay Predictions between the WTRU, RAN, and CN” hereinbelow). Finally, it is possible to empower the PSM 204 with ML techniques to make its decision-making more intelligent.

### Applications and Databases

In this exemplary architecture, applications running at the WTRU may directly interact with the PE 202, PSM 204, and database 208. For example, applications may subscribe to some PE modules 210 to obtain event notifications about a set of predictions (e.g., GPU/CPU usage, available capacity in the next time window) either directly or via the PEC 206. This way, applications may proactively adjust their behaviors, and, in turn, the quality of the user experience (e.g., QoE) may be improved. Recall that the PE modules 210, PSM 204, and databases 208 operate at the application layer, preferably within a virtualized and isolated container.

Applications, PE modules, and the PSM may store their information in a database. This is especially useful for the PE modules 210 that typically need to input the history of particular parameters (e.g., history of WTRU's mobility or GPU/CPU usage). This database may hold information for a short period of time, given that some WTRUs may not be equipped with ample storage (memory) resources. Note that it is also possible to have multiple instances of this database for different activities.

### Delay Predictor Module

The DP module 214 may be integrated into the Predictor Engine (PE) sub-layer 202, which is built on top of a virtualized platform. This is highly beneficial as multiple instances of the DP may operate within a WTRU, predicting packet delays for multiple applications in parallel. In other words, because delays across different applications are very likely to be different due to the locations of ASs and UPFs, each application may run a separate instance of the DP to estimate the possible delay individual to its end-to-end path. FIG. 2 illustrates the integration of a DP 214 in the Predictor Engine (PE) layer 202.

The DP algorithm inputs the delay calculations signaled from the core network (e.g., from the SMF as described above related to a PDU Session. The DP may also feed its optimization algorithm with an end-to-end delay estimate between the WTRU and the AS that is calculated by the WTRU application. Applications may also provide other end-to-end measurements/statistics to the DP, such as packet loss and error rates. In cases where the AS (i.e., FL server) utilizes an AF for managing its session, some further data and analytics may be delivered from the AF to the WTRU, either directly or via the control plane. In the latter case, the AF should send its data to the Network Exposure Function (NEF) first (if it is hosted in an untrusted domain), and then from the NEF, the data is forwarded to the SMF, where it can be delivered to the WTRU via a NAS message (or more precisely via Session Management (SM) signaling). Other predictions available at the WTRU may also be used as state inputs to the DP algorithm, such as predictions from other PE modules (if such an architecture is utilized at the WTRU). Finally, the output of the DP is a set of accurate predictions of the one-way and two-way packet delays between the WTRU and (R)AN, (R)AN and UPF, UPF and AS, and WTRU and AS.

The discussion above discloses delivering packet delay calculations (e.g., delays between the WTRU, (R)AN, and CN) calculated by the entities within the 3GPP system (e.g., UPF) to the WTRU via NAS-SM signaling from the SMF. Also discussed above is a new intelligent component at the WTRU that forecasts packet delays for the WTRU's applications by primarily considering the information provided by packet delay calculations. This also implies that the calculation of the packet delays by the 5GC (more specifically, the UPF) may be used by multiple instances of the DP simultaneously because each application can use a separate instance of the DP. Therefore, this signal may be delivered to a set of DPs in a coordinated manner.

The Delay Predictor (DP) module 214 is a new component that predicts the packet delays between the WTRU, RAN, CN, and AS. The DP may use other predictions, data, logs, and analytics available at the WTRU as its state input to its ML-based algorithm. If the AS utilizes an AF for managing its session-level aspects, the WTRU may also benefit from certain inputs from the AF. These inputs may be delivered to the WTRU either directly over the user plane or via the control plane (e.g., passing through network functions such as the NEF, SMF, and/or AMF).

### Signalling Delay Predictions Between the WTRU, RAN, and CN

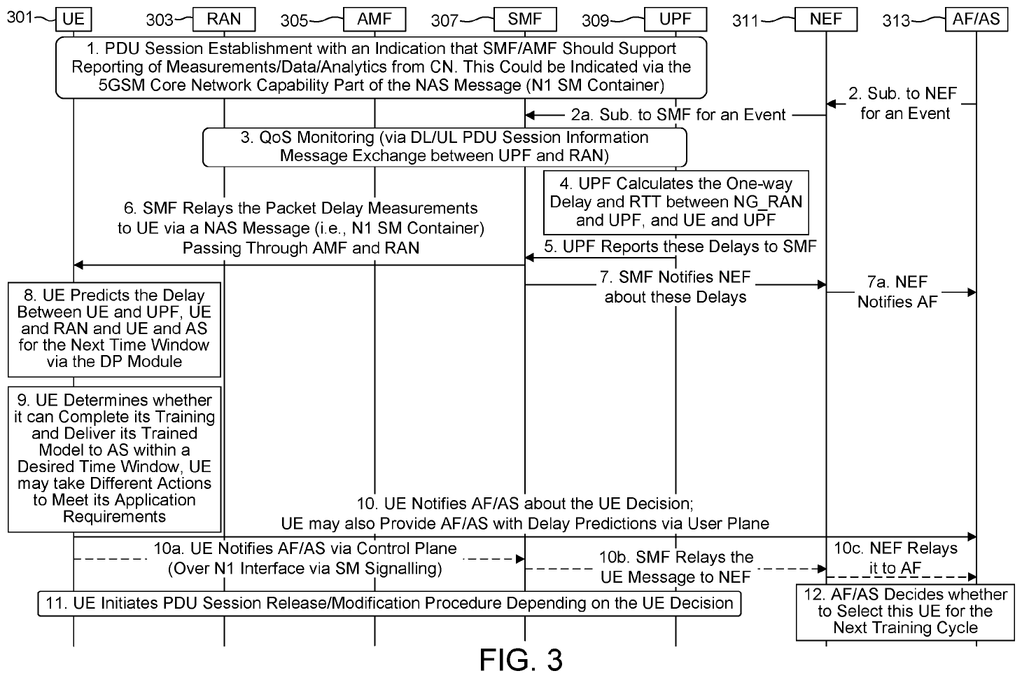

This section discusses how the calculations regarding the packet delay between the various network nodes (e.g., WTRU, RAN, and CN) may be delivered to the WTRU. FIG. 3 is a signal flow diagram illustrating interactions between the WTRU (also indicated as a UE) and the 5GC to realize such functionality.

In step 1, The PDU session establishment message is sent with an indication that SMF/AMF should support the reporting of Measurements/Data/Analytics from the CN. The WTRU 301 sends the NAS PDU Session Establishment message toward the SMF 307 over the N1 interface, passing through the RAN 303 and AMF 305. As part of this NAS message (i.e., N1 SM Container), the WTRU 301 may indicate to the SMF 307 that the WTRU may send some data (including predictions and measurements) to the 5GC NFs over the 5G control plane. This may be signaled via the 5GSM Core Network Capability part of the NAS message. Also, the SMF may want to check with a Unified Data Management/Policy Control Function (UDM/PCF) (not shown) to verify whether the subscriber/WTRU is authorized to use the 5G control plane to interact with 5GC NFs such as NWDAF or AF. The PDU Session Establishment message is also received b the UPF.

In step 2, the Application Function (AF) on behalf of the AF/AS 313 subscribes to one or several Event(s) (identified by Event ID) and provides the associated notification endpoint of the AF by sending a Nnef_EventExposure_Subscribe request as defined in TS 23.502, clause 4.15.3.2.3 [4]. The NEF 311 interacts with the UDM providing its notification endpoint. If the requested event (e.g., the packet delay) requires SMF assistance (as is the case in this example), then the UDM sends the Nsmf_EventExposure_Subscribe request message to the corresponding SMF 307, as shown in step 2a, which serves the WTRU with a notification endpoint of the NEF.

Note that the UDM may also provide its own notification endpoint to the SMF to be notified in parallel with the NEF. For simplicity, the interactions with the UDM are not shown in FIG. 3. For the same reason, the response messages to the request messages are not shown.

Also, note that it is possible for the NEF to store the information about the notified event in the Unified Data Repository (UDR) along with the time stamp using either the Nudr_DM_Create or Nudr_DM_Update service operation as appropriate.

In step 3, the UPF obtains QoS monitoring information as discussed in TS 23.501 [3], clause 5.33.3. To receive various packet delays measurements (e.g., between the WTRU and Next Generation (NG)-RAN, NG-RAN, and PDU Session Anchor (PSA) UPF, PSA UPF and NG-RAN), the QMP (QoS Monitoring Packet) should be enabled within the DL/UL PDU Session Information message, which is exchanged between NG-RAN and PSA UPF regularly (according to an interval decided by UPF/SMF), as defined in TS 38.415 [5]. The UL PDU Session Information carries multiple timestamps (including a timestamp retrieved from the DL PDU Session Information message) which allow the UPF to measure packet delays between different 3GPP entities.

The QoS Monitoring on UL/DL packet delay measurement between NG-RAN and UPF can be performed with different granularities. For example, it may be configured with QoS Flow per WTRU level or per GPRS Tunnelling Protocol User Data (GTP-U) path level. The former case is assumed in FIG. 3. The configuration depends on the operator's local policy and/or AF/PCF [3].

The SMF may activate the end-to-end DL/UL packet delay measurement between the WTRU and UPF for a QoF flow during the PDU Session Establishment or Modification procedure. The SMF should send a QoS Monitoring request to the UPF via N4 signaling and the NG-RAN via N2 signaling [3].

The WTRU and RAN may measure the one-way packet delay and, in turn, Round Trip Time (RTT) regularly for UL and DL through an RRC Measurement Report that can be configured/activated during a PDU Session Establishment and/or Modification procedure. These measurements are reported to the UPF 309 by means of the UL PDU Session Information message.

In step 4, the UPF calculates the one-way and/or two-way packet delay between the RAN-UPF, WTRU-RAN, WTRU-UPF by measurements provided within the UL PDU Session Information signal. In this step, the source of latency related to the user plane within the 3GPP system can be identified, e.g., whether it is coming from the Uu interface between WTRU and RAN or the N3 links between the RAN and UPF.

When these entities are time-synchronized, the one-way packet delay can be obtained between the NG-RAN and PSA UPF. It is worth highlighting that the NG-RAN and WTRU are already time-synchronized. The UPF also may be time-synchronized, provided that the 3GPP system is a time-aware system with its own master clock.

The UPF may signal this information to a trusted/local AF directly or via NEF via the Nupf_EventExposure_Notify service operation if the AF is deployed as a MEC host in a trusted domain. This signaling is not shown in FIG. 3 for simplicity.

In the case of TSC, if the Time Sensitive Communications Assistance Container (TSCTSF) network function receives the Requested 5GS delay, the TSCTSF calculates a Requested PDB (Packet Delay Budget) by subtracting the WTRU-DS-TT residence time from the Requested 5GS delay. This information also may be delivered to the WTRU 301 or AF via the SMF 307 or NEF 311, respectively. This signaling is not shown in FIG. 3 for simplicity.

Next, in step 5, the UPF 309 now reports the packet delay calculations to the SMF 307 via the N4 interface. This report may be triggered when some specific condition is met, e.g., a predefined delay threshold for reporting to SMF is reached.

In step 6, the SMF 307 relays these packet delay calculations to the WTRU 301 via a NAS message (i.e., N1 SM Container) passing through the AMF 305 and RAN 303. The payload container type information element (IE) of the NAS message should be set with a relevant value so that the NAS payload may be correctly identified. A new NAS payload container type may be defined for exchanging data/measurements between the 5GC (SMF in this case) and the WTRU. The SMF 307 may send the NAS message to the AMF 305 via Namf_Communication_N1 N2MessageTransfer. The NAS message type (n1 MessageClass) should be identified in this message (e.g., this could be set to “SM” or a new value to indicate the NAS message class). Once the AMF receives this message, it relays it via another message via the N2 interface (over NG Application Protocol (NGAP)). The AMF 305 creates a DL NAS Transport message with a payload container and includes the PDU Session ID and the NAS payload received from the SMF (which has the packet delay measurements). A new payload container type may be defined (e.g., “data and analytics report”). Currently, to indicate the “SM” message, the “N1 SM information” payload container type should be selected (see 3GPP TS 24.501 V17.3.1 [6], clause 5.4.5). The AMF ciphers and integrity protects the NAS transport message. It is worth highlighting that an Optional IE of a DL/UL NAS Transport message (over N2) also may be used to signal extra information to the NAS's upper layer. Finally, the (R)AN 303 relays this NAS message to the WTRU 301 via an RRC message.

The WTRU may provide the 5GSM Core Network Capability during the PDU Session Establishment/Modification Request. This way, the WTRU can request from the 5G system to select an appropriate AMF/SMF(s) capable of delivering data/measurements/analytics from 5GC NFs to WTRU through the control plane. The AMF/SMF acts as an anchor point, indirectly allowing the WTRU to interact with the 5GC NFs. To request such functionality, a new (extra) element (e.g., “QoS reports from CN”) in TS 23.501 [3], clause 5.4.4b, may be defined, which allows the WTRU to express its request to the 5GS within a NAS message. As a result, during a PDU Session Establishment/Modification procedure, the (R)AN can select an appropriate AMF and/or the AMF can select a proper SMF to handle such data delivery to the WTRU via the 5GC control plane. The AMF/SMF requires sufficient permission (authorization) to allow the WTRU to access the 5GC's measurements/analytics/data produced by 5GC NFs, such as NWDAF. The SMF may need to interact with the PCF/UDM to verify the WTRU permissions (authorization). This verification may be performed as part of a PDU Session Establishment and Modification procedure.

It may be preferable to deliver these packet delay measurements to the WTRU frequently. In this manner, the WTRU may build an accurate history of these measurements (with less time gap between measurements) and use it as a state input to its delay predictor algorithm (e.g., the DP in FIG. 2). Preserving the history of past events is important for an ML algorithm because it mainly helps the ML algorithm to produce a better prediction. That said, it is worth highlighting that reducing the number of control messages between the WTRU and 5GC also may be an important design consideration.

Once this information (delay packet measurements) arrives at the WTRU, it may be routed to the PSM 204 or DP module 214 or an application 212 via PEC 206 (if WTRU follows the architecture presented in FIG. 2) in this manner, e.g., the DP module does not interact with the NAS layer. Instead, the PEC 206 does relay information between the NAS layer and the DP module.

Next, in step 7, the SMF 307 sends an event notification signal to the NEF 311 about these packet delay measurements by means of the Nsmf_EventExposure_Notify message. After that, in step 7a, the NEF 311 notifies the AF/AS 313 via the Nnef_EventExposure_Notify message. The NEF may store the information in the UDR along with the time stamp using either Nudr_DM_Create or Nudr_DM_Update service operation as appropriate. The event notification may be triggered when a measured delay exceeds a certain threshold instructed by the AF and/or PCF policy rules.

In step 8, upon receiving the delay information, the WTRU 301 predicts the (one-way) delay between the WTRU 301 and the UPF 309, the WTRU 301 and the RAN 303, as well as the end-to-end delay between the WTRU 301 and the AF/AS 313 for the next window of time. The WTRU may utilize the DP module 214 (see FIG. 2) to produce such predictions. The DP module may use a Reinforcement Learning technique such as A3C [8], DDPG [9], SAC [10], or other ML techniques. The DP may also use some measurements provided by the WTRU application, such as end-to-end latency, jitter, and loss rate, as state inputs to its ML algorithm. The latter may be crucial, given that such information is unavailable in 5GC. As a result, having access to the relevant data set, the WTRU is the best-positioned entity in the 3GPP system to produce such predictions.

In step 9, the WTRU determines whether it can deliver its trained model to the AI/ML application server (AS) within a required window of time. For such determination, the WTRU may utilize other available predictions and data/analytics within the WTRU, notably prediction of GPU/CPU load, available bitrate, and mobility pattern. As highlighted in FIG. 2, it is possible to utilize the PDU Session Modifier (PSM) module 204 to perform such a determination and, in turn, take appropriate action accordingly (e.g., initiating a PDU Session Modification/Release procedure, see step 9). Alternatively, a standalone ML-empowered component may be utilized to make such a determination. As a result of the determination, the WTRU may take different actions to meet its application requirements.

Note that the PSM module 204 is designed to optimize all PDU Sessions on behalf of applications. The PSM has an interface with the NAS layer (i.e., the NAS-MM layer [3]). Applications can register with PSM via RESTful APIs over HTTP, expressing their requirements. The PSM then may try to meet their requirements by optimizing corresponding PDU Sessions. The PSM may subscribe (via an EventExposure like service operation commonly used in 5GC network functions) to several predictor modules (e.g., the DP module 214) in the (PE) layer 202 either directly or via the PEC module 206 (see FIG. 2).

In step 10, the WTRU 301 may wish to notify the AF/AS 313 about the WTRU decision. The WTRU may further provide the AF/AS with a set of predictions/analytics/data/logs. The latter could be useful for the AS to decide whether to select this WTRU for the next training cycle (at step 12). To send such notifications from the WTRU application to the AF/AS, the WTRU application may subscribe to the DP 214 and/or other PE modules directly or via the PEC module 206 to obtain the required event notifications as they become available. A similar service operation such as EventExposure_Notify, which is heavily used within 5GC, may be utilized. The PEC 206 may communicate directly with the AF/AS via the user plane or control plane (step 10a). The latter may be performed via the NAS-SM signaling where the WTRU's data is carried over the N1 SM container with a new NAS message type. This new message is relayed by the SMF 307 to its AF/AS destination 313 either directly or via NEF 311, (see step 10b, 10c) depending on whether the destination network function (NF) 311 is hosted in a trusted domain or not. Additional information may be added to the NAS message to guide the SMF 307 to forward the message to its destination. It is worth highlighting that SMF communication to other 5GC NFs may be performed via Service Based Interface (SBI).

In step 11, if the WTRU has determined that it cannot complete the local training on time or that the 3GPP system delay and/or end-to-end latency will be too long for the AI/ML application server to receive the WTRU local trained model on time, the WTRU may decide to release the PDU Session resources by initiating the PDU Session Release procedure. Alternatively, the WTRU may initiate the PDU Session Modification procedure to increase the resources of the PDU Session if it determines that such action will help the trained model arrive on time (before its deadline). The component responsible for making such decisions might be the PSM 204 in FIG. 2, which has an overarching view of all active PDU Sessions, applications, and available resources. Note that the PSM may change the priority of FL traffic or select different network slices for FL traffic as part of a PDU Session Modification procedure.

In the case of releasing the PDU Session, the WTRU may send a NAS message (e.g., triggered by PSM) with the following content: NAS message (N1 SM Container (PDU Session Release Request (PDU Session ID)), PDU Session ID). The message may get forwarded by the NG-RAN 303 to the AMF 305 with an indication of User Location Information (ULI). This message may then be relayed from the AMF 305 to the SMF 307 by invoking the Nsmf_PDUSession_UpdateSMContext service operation. As part of this operation, the AMF may provide the N1 SM container (i.e., the NAS PDU, which includes the PDU Session Release Request message and PDU Session ID) to the SMF and the ULI information received from the NG-RAN. The SMF may decide between keeping the PDU Session with the user plane connection deactivated or releasing the PDU Session resources in the core network. In the latter case, the SMF may release PDU Session resources at the UPF by sending the N4 Session Release Request message to the UPF 309. A response message will be sent from the UPF 309 to the SMF 307 as an acknowledgment. The SMF 307 then may send the response to the AMF 305 via the Nsmf_PDUSession_UpdateSMContext response message, which may include: N2 SM Resource Release Request, and/or N1 SM Container (PDU Session Release Command (PDU Session ID, Cause)). The former causes the RAN resources to be released. At this stage, the NG-RAN 303 may relay the NAS message (N1 SM container (PDU Session Release Command)) to the WTRU 301 in an RRC message. The WTRU 301 may acknowledge the PDU Session Release Command by sending a NAS message (N1 SM container (PDU Session Release Ack)) over the NG-RAN 303. The NG-RAN may forward the NAS message received from the WTRU to the AMF 305 through an N2 NAS Uplink Transfer message (NAS message (N1 SM container (PDU Session Release Ack))). Then, the AMF 305 may relay the NAS message (N1 SM container (PDU Session Release Ack)) to the SMF 307 by invoking the Nsmf_PDUSession_UpdateSMContext service operation. The SMF 307 may respond accordingly to the AMF 305 via the same service operation.

In the case of modifying an existing PDU Session, the WTRU 301 (e.g., the PSM entity 204) may initiate the PDU Session Modification procedure by the transmitting a NAS message (N1 SM container (NAS PDU Session Modification Request (PDU Session ID, Packet Filter Operation, Requested QoS, Segregation, 5GSM Core Network Capability, Number of Packet Filter, so on))). The NAS message may then be forwarded by the RAN 303 to the AMF 305. The AMF may invoke the Nsmf_PDUSession_UpdateSMContext service operation carrying SM Context ID and N1 SM container (NAS PDU Session Modification Request). It is worth noting that, as part of 5GSM Core Network Capability, the WTRU may be able to express that the AMF/SMF should be capable of reporting data from the CN to the WTRU via a NAS message. Next, the SMF 307 may update the UPF 309 with N4 Rules related to new or modified QoS Flow(s). The UPF 309 may send a response message to the SMF 307 via an N4 message. Then, the SMF 307 may send a response message to the AMF 305 through a Nsmf_PDUSession_UpdateSMContext Response message ([N2 SM information (PDU Session ID, QFI(s), QoS Profile(s), [Alternative QoS Profile(s)], Session-AMBR]), N1 SM container (NAS PDU Session Modification Command (PDU Session ID, QoS rule(s), QoS rule operation, QoS Flow level QoS parameters (if needed for the QoS Flow(s) associated with the QoS rule(s)), Session-AMBR, etc.)). The AMF 305 may send this information over an N2 message to the RAN 303. Depending on the content of the message received from the SMF, the RAN may follow specific signaling to interact with the WTRU. For example, with NG-RAN, an RRC Connection Reconfiguration may be exchanged with the WTRU modifying the necessary NG-RAN resources related to the PDU Session. Alternately, if the message received from the AMF only contains information regarding the N1 SM container, then the RAN may only transport that to the WTRU. Next, the WTRU 301 may acknowledge the PDU Session Command message received from the RAN 303 by sending a NAS message comprising an N1 SM container (NAS PDU Session Modification Ack) part. The RAN 303 may forward the NAS message to the AMF 305 via an N2 NAS Uplink Transfer message. The AMF 305 may forward the NAS message to the SMF 307 via Nsmf_PDUSession_UpdateSMContext service operation. The SMF 307 may send a response message to the AMF 305 accordingly. Finally, the SMF 307 may update the N4 session of the UPF(s) 309 that are involved by the PDU Session Modification by sending N4 Session Modification Request to the UPF9s) 309.

Finally, in step 12, the AF/AS 313 now may have access to several WTRU predictions, data, measurements, and thus can more easily determine whether to select this WTRU for the next training cycle. The decision may depend solely on the WTRU's decision regarding the PDU Session made at step 9. For example, if the WTRU has triggered the PDU Session Release procedure, the AF/AS may decide not to select this WTRU for the next training cycle.

Alternately, the AF/AS may consider other information provided by the WTRU (e.g., predictions, data, logs, measurements, etc.) or 5GC (e.g., analytics produced from NWDAF instances [7]) in making such determinations.

### Network Exposure Anchor Function Using AMF or SMF

The example described below uses the AMF or SMF acting as a network exposure anchor function (NEAF) for the WTRU. The NEAF may also be realized using a dedicated function or may be co-located with an existing NF (e.g., AMF, SMF, or as an extension of a Local-NEF (L-NEF)).

Unlike the existing Network Exposure Function that provides exposure of Network Services to AFs, the NEAF interacts with the WTRU and as such the NEAF may need to consider WTRU specific procedures when delivering Exposure Functionality, e.g., by taking advantage of messages (e.g., to piggyback notifications) required for the normal execution of WTRU functionality such as Registration and PDU Session Establishment

### WTRU Actions

A WTRU may have one or more of the following actions with regard to the NEAF:
a. The WTRU may send a subscription request using NAS messages (e.g., Registration or PDU Session Establishment). The WTRU may include a network exposure service id (e.g., location tracking, slice load), and/or a network exposure session id. A WTRU includes the network exposure service specific parameters that are being subscribed to (e.g., Id of WTRU to be tracked, id of slice, event threshold). A WTRU includes a notification mode preference (NAS, UP, immediate, or deferred/periodic). A WTRU receives a subscription response with acceptance of subscription, including the network exposure id and session id, network exposure reception configuration parameters (e.g., NAS or UP, protocol parameters, addressing configuration information to receive network exposure payload over UP), optional specific network exposure payload (e.g., target WTRU location, slice load level), and the like. A WTRU receives a specific network exposure payload via subsequent NAS messages that includes the network exposure service id and/or session id or via user plane (UP) packets to the configured exposure receiving endpoint.
b. A WTRU indicates network exposure service capabilities when registering with the network.
c. A WTRU receives a network exposure service configuration. The Network may derive the service configuration based on static Subscriber Information (e.g., the UDM may store information as to whether what services the WTRU is allowed to access) or it may be based on dynamic policy association. For example, the UDM may use the existing Network Slice Configuration to determine NF the WTRU is allowed to access based on e.g., the Allowed Network Slice Selection Assistance Information (NSSAI), and provide exposure capabilities only from NFs that are part of these network slices.

### Service Logic

The WTRU that is interested in network exposure may subscribe (i.e., registers with the network) to Network Exposure Services (NES) e.g., as part of the initial Registration and it can subsequently be modified/request new Network Exposure Services e.g., using a mobility Registration, or PDU Session Establishment procedure. If the WTRU does this through a Registration procedure, the WTRU may request NES through the AMF. This hop by hop NAS message between WTRU and AMF is confidentiality, integrity, and replay protected using pre-established NAS security and contains a signaling envelope directed at SMF. Note that depending on the requested Network Exposure Service, the AMF may handle the request (e.g., if the request pertains to Access and Mobility Management events) or it may forward the message to another NF, either using the existing e.g., Nsmf_EventExposure_Subscribe service operation, or just relaying the NAS message over e.g., through a Nsmf_PDUSession_Create service operation.

The WTRU is authorized by the AMF/SMF for the network capability exposure where the AMF/SMF is the anchor point of the service flow. The dynamic control of the service can be enforced by an AF through the PCF that will be enforced by the AMF or SMF. The WTRU subscription info from the UDM and service policy are in placed in the AMF/SMF after the WTRU successful primary authentication or obtained during PDU Session establishment (e.g., Network exposure as part of Session Management Function (SMF) subscription information).

Upon activation of the notification/exposure, the SMF contacts AMF with the notification envelope to be forwarded to the WTRU protected using hop to hop NAS security or using a service-based interface (SBI) service operation e.g., Nsmf_EventExposure_Notify service operation. The notification/network event exposure envelope also contains a notification identity. Concurrently, SMF may use the PDU Session associated to the Network Exposure Session ID which the Network Exposure Request was received to send a body of the notification (e.g., when it contains an optionally large volume of notification/exposure information) to the UPF. The UPF is sending the optionally large volume of notification/network exposure information to the WTRU over the UP using optional UP security. If UP security is not available, but the network exposure information needs to be protected, it has to be enveloped and protected independently from the more general UP security policy.

The UPF sends notification event identity together with the notification/exposure information so that the WTRU can collate the notifications received over UP with subscription/registrations initially sent over NAS and notification indications received over NAS. For example, the WTRU uses the Network Exposure Session and Service IDs to deliver the notification to the relevant application.

Optionally, if the separation of network indication over NAS and notification/network status exposure over the UP is not needed, the notification may indicate (e.g., by signaling with notification identity=NULL) that the network exposure information is enclosed in the same NAS message and collating with the UP is not required.

Also, optionally, the action of subscription, while being signaling in nature and performed over NAS, may be followed by the subscription confirmation over the UP with NULL event content but correct notification event identity that corresponds to the NAS subscribe message.

The event notification/network exposure subscription may be terminated in the following ways:
a. from the WTRU: over NAS and to SMF through AMF (WTRU-initiated termination), or
b. from the SMF through AMF and further over NAS to the WTRU (network-initiated termination).

### Service Flow for Subscribe/Notification of Network Exposure to WTRU

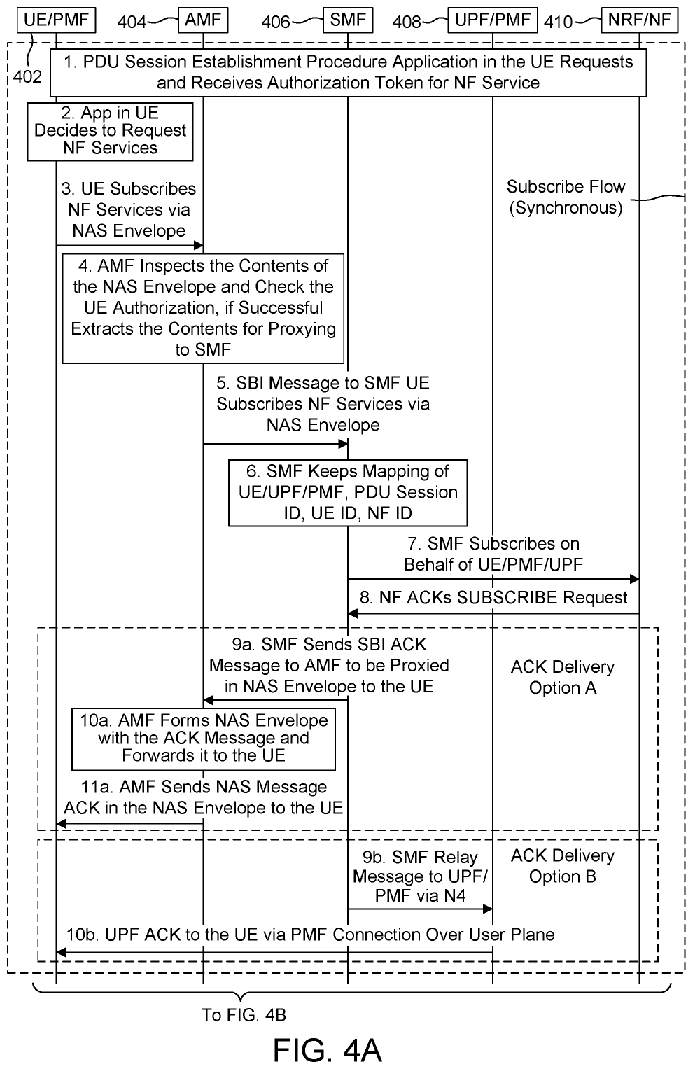

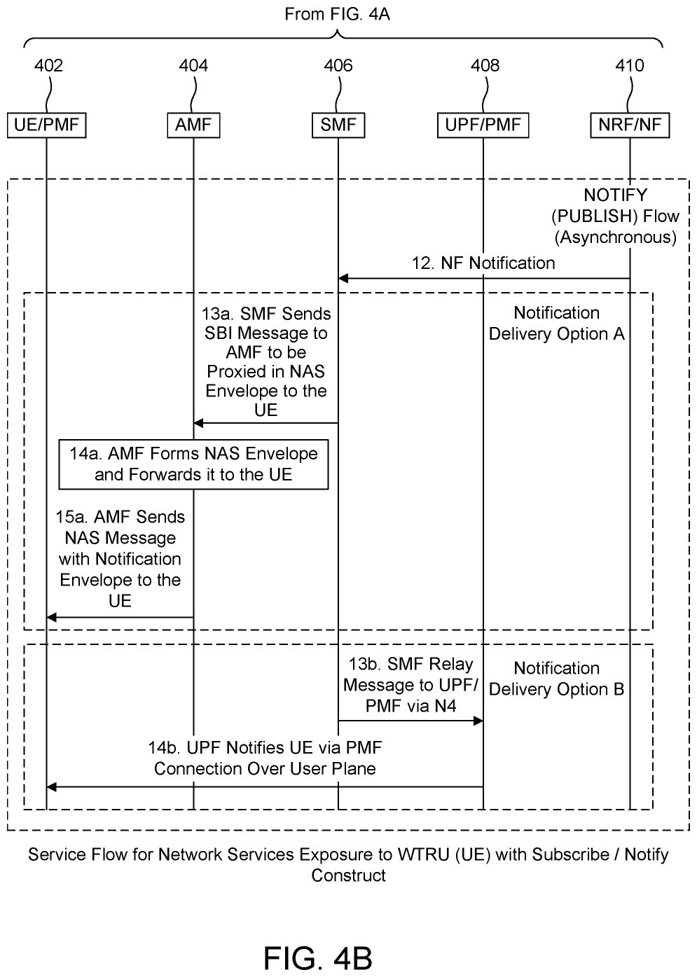

FIG. 4A depicts an example service flow for network services exposure to WTRU with a subscribe/notify construct. The subscribe flow in FIG. 4A is synchronous. At FIG. 4A, Step 1, WTRU/Performance Management Function (PMF) 402 (also indicated as a UE/PMF) sets up PDU session with the network. A PDU session establishment procedure application in the WTRU requests and receives authorization token for network function (NF) service. At Step 2, the application in the WTRU 402 decides to request to network function service. At Step 3, the WTRU 402 issues a NAS message to the AMF 404 to subscribe to NF services. This NAS message is confidentiality, integrity, and replay protected using pre-established NAS security and contains a signaling envelope directed at SMF 406. At Step 4, AMF 404 opens the NAS envelope and verifies that the WTRU is authorized to use the network exposure service from the UDM subscription information. If authentication is successful, the AMF extracts the contents for proxying to the SMF. The AMF 404 then checks the service policy received from the AF that was formulated by the AF and delivered via PCF for the WTRU dynamic network service control, e.g., policy for a location tracking to a target device for certain duration and area boundary. The AMF 404 uses its contents to request the network service on behalf of the WTRU denoted by either Subscription Permanent Identifier (SUPI) or any other permanent WTRU identifier to the network event(s) of interest (e.g., change of an object state, network event). At Step 5, the AMF 404 shapes the SBI message and sends it to the SMF 406 with the content from the NAS envelope. The IEs in the NAS envelope identify the network services/information to which the WTRU is subscribing (e.g., location, “slice load”). The AMF 404 can perform the discovery of the NF 410 from the network repository function (NRF) before routing the service exposure message to the correct NF. At Step 6, the SMF subscribes to the network service on behalf of UE/PMF/UPF. The SMF keeps the mapping between UE/UPF/PMF, PDU session ID, and NF ID.

In FIG. 4A, at Step 7, the NF 410 receives the subscription message from the SMF 406 on behalf of the WTRU 402. The NF 410 validates subscription message and authorization of WRTU subscription. If the validation is successful, the NF 410 then acknowledges the SUBSCRIBE request at Step 8.

In one acknowledgement delivery option A of FIG. 4A, at Step 9a, upon activation of the subscription, the SMF 406 contacts AMF 404 with the ACK envelope (proxied in a NAS envelope) to be forwarded to the WTRU 402. The ACK envelope may contain a SUBSCRIBE identity. At Step 10a, the AMF 404 extracts the content from the message just received from the SMF 406 and shapes the NAS message that is confidentiality, integrity, and replay-protected using pre-established NAS security credentials shared with the WTRU 402. Note that such a “split subscribe/notify” choice of architecture provides optimization since there is no need to establish a new UP bearer before transmitting an actual notification/network exposure. In addition, not every notification/network exposure is large enough to warrant a UP bearer establishment. In FIG. 4A at Step 11a, the AMF 404 sends a NAS message acknowledge to the WTRU 402 to acknowledge in the NAS envelope.

In another acknowledgement delivery option B of FIG. 4A, at Step 9b, the SMF 406 sends a body of the acknowledge (ACK) to the UPF/PMF 408 over the N4 signaling interface. At Step 10b, the UPF/PMF 408 sends the SUBSCRIBE ACK over the User Plane to the WTRU 402.

FIG. 4B is a continuation of FIG. 4A depicting an example service flow for network services to a WTRU (also indicated as a UE) with notification options. In FIG. 4B, the notification related to a publishing flow that may be considered to be asynchronous. In FIG. 4B, at Step 12, when the trigger for the network exposure event is fired, the NF 410 first checks the WTRU 402 client authorization. If authorized, the NF 410 sends the notification/network exposure information to the SMF 406.

In FIG. 4B, a notification delivery option A is depicted. At Step 13a, upon receiving the event notification, the SMF 406 packs the message in SBI body (proxied in a NAS envelope) and forwards the message to the AMF 404. The notification/network event exposure envelope also contains a notification identity. If the separation of network indication over NAS and notification/network status exposure over the UP is not needed, the notification may indicate (e.g., by signaling with notification identity=NULL) that the network exposure information is enclosed in the same NAS message and collating with the UP is not required.

At Step 14a, the AMF 404 extracts the content from the message just received from the SMF 406 and creates the NAS message with NAS envelope containing notification payload that is confidentiality, integrity, and replay-protected using pre-established NAS security credentials shared with the WTRU 402. At Step 15a, the NAS message is then forwarded to the WTRU 402 over NAS.

In FIG. 4B, a notification delivery option B is also depicted. In Step 13b, the SMF 406 sends a body of the notification (e.g., containing an optionally large volume of notification/exposure information) to the UPF/PMF 408 over the N4 signaling interface. The UPF 408 sends notification event identity together with the notification/exposure information to the WTRU so that the WTRU can correspond with the notifications received over UP with subscription/registrations initially sent over NAS and notification indications received over NAS. At Step 14b, the UPF/PMF 408 may send a large volume of notification information to the WTRU 402 via PMF connection over the user plane, using optional UP security. If UP security is not available, but the network exposure information needs to be protected, network exposure information may be enveloped and protected independently from the more general (over the air) UP security credentials and policy.

### Service Flow for Request/Response of Network Exposure to WTRU

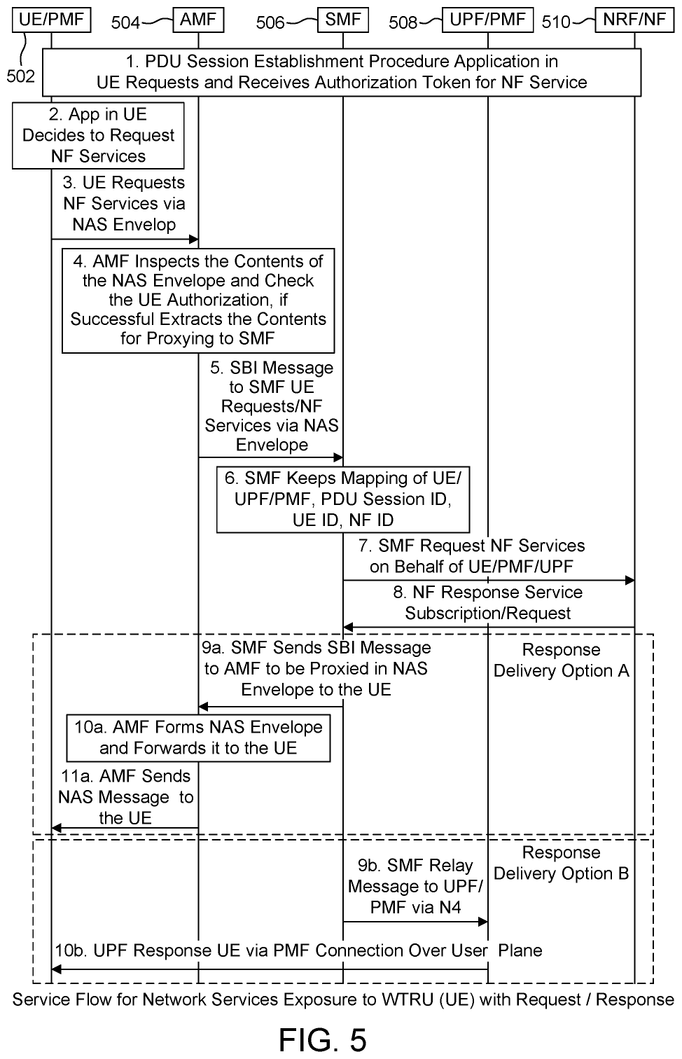

FIG. 5 depicts an example service flow for network services exposure to WTRU (also indicated as a UE) with a request/response. At FIG. 5, Step 1, the WTRU 502 sets up PDU session with the network. This includes conducting a PDU session establishment procedure, where the application in the WTRU requests and receives an authorization token for NF service At Step 2, the application in WTRU 502 decides to request network service. At Step 3, the WTRU issues a NAS message to the AMF 504. This NAS message is confidentiality, integrity, and replay protected using pre-established NAS security and contains a NAS signaling envelope directed at SMF 506. At Step 4, the AMF 504 opens the NAS envelope and verifies that the WTRU 502 is authorized to use the network exposure service from the UDM subscription information. If successful, the AMF extracts the contents of the NAS envelope for proxying to the SMF. The AMF 504 then checks the service policy received from the AF that was formulated by the AF and delivered via PCF for the WTRU 502 dynamic network service control, e.g., policy for a location tracking to a target device for certain duration and area boundary. The AMF 504 uses its contents to request the network service on behalf of the WTRU denoted by either SUPI or any other permanent WTRU identifier to the network event(s) of interest (e.g., change of an object state, network event). At Step 5, The AMF 504 shapes the SBI message and sends it to the SMF 506 with the content from the NAS envelope. The IEs in the NAS envelope identify the network services/information to which the WTRU 502 is subscribing (e.g., location, “slice load”). The AMF 504 can perform the discovery of the NF 510 from the NRF before routing the service exposure message to the correct NF.

In FIG. 5, at Step 6, the SMF 506 opens the NAS envelope and uses its contents to request the network service on behalf of subscriber WTRU 502 denoted by either SUPI or any other permanent UE identifier to the network event(s) of interest (e.g., change of an object state, network event). The SMF 506 keeps mapping between WTRU/UPF/PMF, PDU session ID, and NF ID.

At Step 7, the SMF 506 requests the network service on behalf of WTRU/PMF/UPF via message sent to the NRF/NF 510. At Step 8, the NF 510 validates security of the request message. If the validation is successful, the NF 510 then responds to the SMF 506 with the network exposure service information.

In one option in FIG. 5, an acknowledgement (ACK) delivery option A, has example steps 9a, 10a, and 11a. In Step 9a of FIG. 5, upon receiving the network exposure information at Step 8, the SMF 506 contacts AMF 504 with network exposure service information that contains a request identity. If the separation of network indication over NAS and network exposure service data over the UP is not needed, the network exposure information is enclosed in the same NAS message. Thus, at Step 9a, the SMF 506 sends an SBI ACK message to the AMF 504 to be proxied in NAS envelope to the WTRU 502. Note that such a “split request/response” choice of architecture provides optimization since there is no need to establish a new UP bearer before transmitting an actual network exposure. In addition, not every network exposure information is large enough to warrant a costly and time-consuming UP bearer establishment.

In Step 10a, the AMF 504 extracts the content from the message just received from the SMF 506 and formulates the NAS message that is confidentiality, integrity, and replay-protected using pre-established NAS security credentials shared with the WTRU 502. At Step 11a, the NAS message is then forwarded to the WTRU 502 over NAS.

In another option, an acknowledgement (ACK) delivery option B, has example Steps 9b and 10b. At Step 9b, the SMF 506 sends a body of the response (e.g., containing an optionally large volume of exposure information) to the UPF/PMF 508 over the N4 signaling interface. UPF 508 sends request identity together with the exposure information so that the WTRU can correspond to the received response over UP with the request initially sent over NAS. At Step 10b, the UPF/PMF 508 sends the large volume of network exposure information to the WTRU 502 via PMF connection over the user plane, using optional UP security. If UP security is not available, but the network exposure information needs to be protected, network exposure information may be enveloped and protected independently from the more general UP security policy.

### Service Flow of the WTRU Terminating Network Exposure Subscription

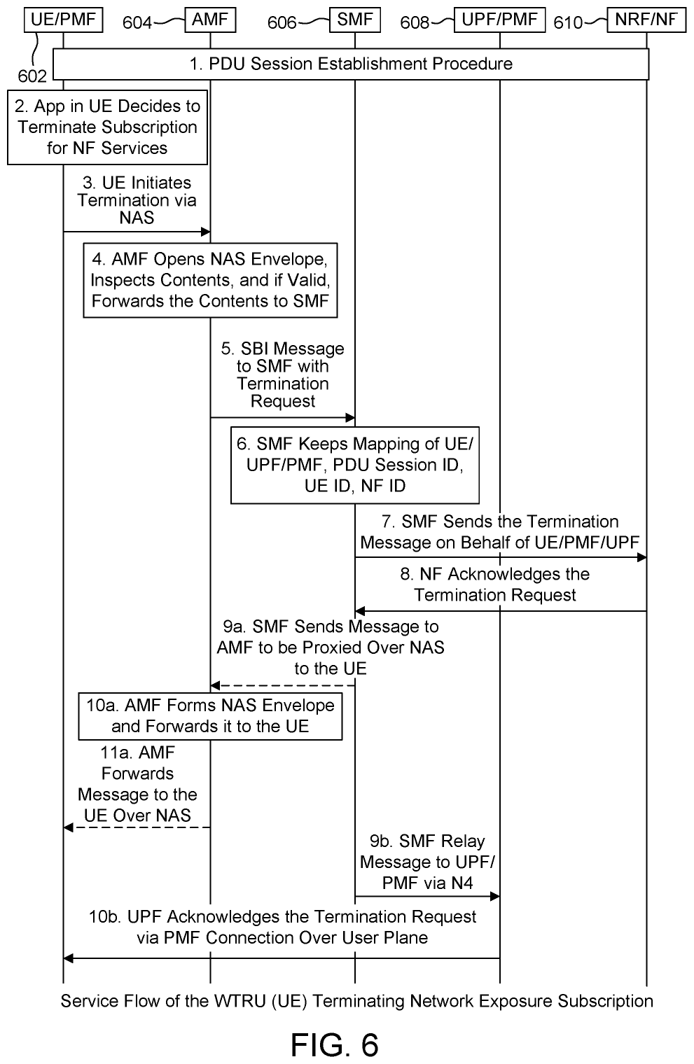

FIG. 6 depicts an example service flow for network services exposure to WTRU (also indicated as a UE) with a termination request. At FIG. 6, Step 1, the WTRU 602 sets up PDU session with the network. At Step 2, the application in WTRU 602 decides to request a termination to a subscription for NF services. At Step 3, the WTRU 602 issues a NAS message to the AMF 504. This NAS message is confidentiality, integrity, and replay protected using pre-established NAS security and contains a signaling envelope directed at SMF 606. The message contains a termination request for subscription to the NF services with information, such as termination cause and link to the individual application session context. At Step 4, the AMF 604 opens the NAS envelope and verifies that the WTRU 602 is authorized to use the network exposure service from the UDM subscription information. The AMF 604 then checks the service policy received from the AF that was formulated by the AF and delivered via PCF for the WTRU 602 dynamic network service control. The AMF forwards the contents to the SMF. The AMF 604 uses its contents to request a termination of the network service on behalf of the WTRU 602 denoted by either SUPI or any other permanent UE/WTRU identifier to the network event(s) of interest (e.g., change of an object state, network event). At Step 5, The AMF 604 shapes the SBI message and sends it to the SMF 606 with the termination request content from the NAS envelope. The IEs in the NAS envelope identify the network services/information to which the WTRU 602 is terminating the subscription.

In FIG. 6, at Step 6, the SMF 606 keeps the mapping of the WTRU/UPF/PMF, PDU Session ID, WTRU ID, and NF ID.

At Step 7, the SMF 606 requests the network service termination on behalf of WTRU/PMF/UPF via message sent to the NRF/NF 610. At Step 8, the NF 610 validates security of the termination request message. If the validation is successful, the NF 610 then responds to the SMF 606 with the termination of network exposure service information.

In one option in FIG. 6, an acknowledgement (ACK) delivery option A, has example steps 9a, 10a, and 11a. In Step 9a of FIG. 6, upon receiving the network exposure termination information at Step 8, the SMF 606 contacts AMF 604 with network exposure service termination information, that contains a request identity. If the separation of network indication over NAS and network exposure service data over the UP is not needed, the network exposure information is enclosed in the same NAS message. Thus, at Step 9a, the SMF 606 sends an SBI ACK message to the AMF 604 to be proxied in NAS envelope to the WTRU 602.

In Step 10a, the AMF 604 extracts the content from the termination acknowledgement message just received from the SMF 606 and formulates the NAS message that is confidentiality, integrity, and replay-protected using pre-established NAS security credentials shared with the WTRU 602. At Step 11a, the NAS message is then forwarded to the WTRU 602 over NAS.

In another option in FIG. 6, an acknowledgement (ACK) delivery option B, has example Steps 9b and 10b. At Step 9b, the SMF 606 sends a body of the response (e.g., containing an optionally large volume of exposure information) to the UPF/PMF 608 over the N4 signaling interface. UPF 608 sends request identity together with the exposure information so that the WTRU can correspond to the received response over UP with the request initially sent over NAS. At Step 10b, the UPF/PMF 608 sends the termination request of network exposure information to the WTRU 602 via PMF connection over the user plane, using optional UP security. If UP security is not available, but the network exposure information needs to be protected, it is desirable to be enveloped and protected independently from the more general UP security policy.

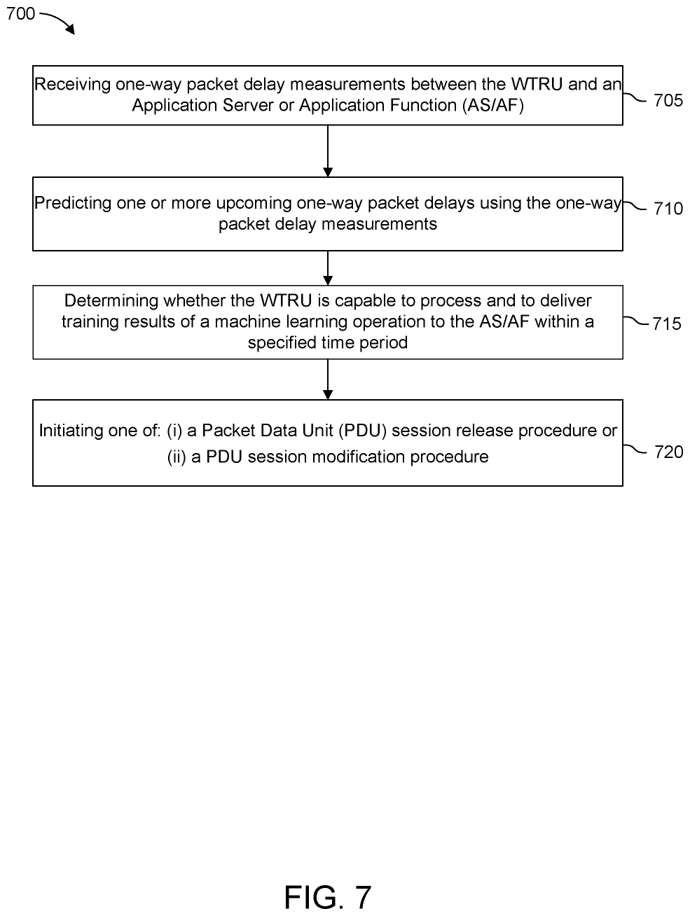

FIG. 7 is a flow diagram describing an example method 700 of a WTRU to control resource usage associated with the delivery of training results for a machine learning operation. FIG. 7 is an example method employing some of the features of FIG. 3.

At 705, the WTRU receives one-way packet delay measurements between the WTRU and an application server/application function. At 705, the WTRU may receive the one-way packet delay measurements via non-access stratum session management signaling from a user plane function.

At 710 the WTRU predicts at least one upcoming one-way packet delay using the received one-way packet delay measurements of step 705. The predicted upcoming one-way packet delays are predicted one-way delays between the WTRU and the application server/application function. The prediction of the one or more upcoming one-way packet delays includes predicting upcoming packet delays between any of (i) the WTRU and a radio access network, (ii) the radio access network and a core network, (iii) the core network and the application server/application function, and (iv) the WTRU and the application server/application function. The prediction may further include using a history of packet delay measurements to predict upcoming one or more one-way packet delays.

At 715, the WTRU determines whether it is capable (can successfully or unsuccessfully) to process and deliver training results of the machine learning operation to the application server/application function within a specified time period. The determination of the capability (the ability/can successfully) to process and deliver the training results may be based on the WTRU's prediction of the upcoming one-way packet delays.

At 720, the WTRU initiates, based on the determination of capability (ability to successfully or unsuccessfully process and deliver) at step 715, either a packet data unit session release procedure or a packet data unit session modification procedure.

The initiating of either the packet data unit session release procedure or the packet data unit session modification procedure may include initiating a procedure for use by an artificial intelligence/machine learning application of the application server/application function.

The initiating of either the packet data unit session release procedure or the packet data unit session modification procedure may also include initiating the packet data unit session release procedure on condition that the predicted upcoming one or more one-way packet delays inhibit a transmission of the training results within the specified time period. The initiating of either the packet data unit session release procedure or the packet data unit session modification procedure may also include initiating the PDU session modification procedure on condition that the WTRU determines to increase resources to assist a transmission of the training results within the specified time period. Alternately, the initiating of the one the packet data unit session release procedure or the packet data unit session modification procedure may include initiating the packet data unit session modification procedure on condition that the WTRU determines to decrease resources when not needed to transmit the training results within the specified time period.

The example method 700 may further include predicting upcoming two-way packet delays between any of the WTRU and a radio access network, the radio access network and a core network, the core network and an application server/application function, and the WTRU and the application server/application function.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

### REFERENCES

The following references may have been referred to hereinabove and are incorporated in full herein by reference.
[1] The Impact of 5G: Creating New Value across Industries and Society (weforum.org, January 2020). https://cutt.ly/Pm5llMt.
[] 3GPP TS 23.548 V17.0.0 (2021-09). 5G System Enhancements for Edge Computing; Stage 2 (Release 17).
[3] 3GPP TS 23.501 V17.1.1 (2021-06). System architecture for the 5G System (5GS); Stage 2 (Release 17).
[4] 3GPP TS 23.502 V17.1.0 (2021-06). Procedures for the 5G System (5GS); Stage 2 (Release 17).
[5] 3GPP TS 38.415 V16.0.0 (2021-12). NG_RAN; PDU Session User Plane Protocol; (Release 16).
[6] 3GPP TS 24.501 V17.5.0 (2021-12). Non-Access-Stratum (NAS) protocol for 5G System (5GS); Stage 3; (Release 17).
[7] 3GPP TS 23.288 V17.1.0 (2021-06). Architecture enhancements for 5G System (5GS) to support network data analytics services (Release 17)
[8] V. Mnih, A. P. Badia, M. Mirza, A. Graves, T. Lillicrap, T. Harley, D. Silver, and K. Kavukcuoglu, “Asynchronous methods for deep reinforcement learning,” in International conference on machine learning. PMLR, 2016, pp. 1928-1937.
[9] T. P. Lillicrap, J. J. Hunt, A. Pritzel, N. Heess, T. Erez, Y. Tassa, D. Silver, and D. Wierstra, “Continuous control with deep reinforcement learning,” arXiv preprint arXiv:1509.02971, 2015.
[10] T. Haarnoja, A. Zhou, P. Abbeel, and S. Levine, “Soft actor-critic: Offpolicy maximum entropy deep reinforcement learning with a stochastic actor,” in International Conference on Machine Learning. PMLR, 2018, pp. 1861-1870.

What is claimed is:

1. A method implemented in a Wireless Transmit Receive Unit (WTRU) for controlling resource usage associated with delivery of training results for a machine learning operation, the method comprising:
receiving, at the WTRU, one-way packet delay measurements between the WTRU and an Application Server or Application Function (AS/AF);
predicting one or more upcoming one-way packet delays using the received one-way packet delay measurements, the predicted one or more upcoming one-way packet delays comprise predicted one-way delays between the WTRU and the AS/AF;
determining whether the WTRU is capable to process and to deliver training results of the machine learning operation to the AS/AF within a specified time period based on the predicted one or more upcoming one-way packet delays; and
sending a message indicating, based on the determination, one of: (i) a Packet Data Unit (PDU) session release or (ii) a PDU session modification.

2. The method of claim 1, wherein the receiving, at the WTRU, the one-way packet delay measurements comprises receiving the one-way packet delay measurements via non-access stratum session management (NAS-SM) signaling from a user plane function (UPF).

3. The method of claim 1, wherein the predicting of the one or more upcoming one-way packet delays comprises predicting upcoming packet delays between any of (i) the WTRU and a radio access network (RAN), (ii) the RAN and a core network (CN), (iii) the CN and the AS/AF, and (iv) the WTRU and the AS/AF.

4. (canceled)

5. (canceled)

6. The method of claim 1, wherein the message is sent based on a condition that the predicted upcoming one or more one-way packet delays inhibit a transmission of the training results within the specified time period.

7. The method of claim 1, wherein the message is sent based on a condition that the WTRU determines to increase resources to assist a transmission of the training results within the specified time period.

8. The method of claim 1, wherein the message is sent based on a condition that the WTRU determines to decrease resources when not needed to transmit the training results within the specified time period.

9. (canceled)

10. A wireless transmit/receive unit (WTRU) comprising:
a processor configured to:
receive, at the WTRU, one-way packet delay measurements between the WTRU and an Application Server or Application Function (AS/AF);
predict one or more upcoming one-way packet delays using the received one-way packet delay measurements, the predicted one or more upcoming one-way packet delays comprise predicted one-way delays between the WTRU and the AS/AF;
determine whether the WTRU is capable to process and to deliver training results of the machine learning operation to the AS/AF within a specified time period based on the predicted one or more upcoming one-way packet delays; and
sending a message to indicate, based on the determination, one of: (i) a Packet Data Unit (PDU) session release or (ii) a PDU session modification.

11. The WTRU of claim 10, wherein the processor is configured to receive the one-way packet delay measurements via non-access stratum session management (NAS-SM) signaling from a user plane function (UPF).

12. The WTRU of claim 10, wherein the processor is configured to predict the one or more upcoming one-way packet delays between any of (i) the WTRU and a radio access network (RAN), (ii) the RAN and a core network (CN), (iii) the CN and the AS/AF, and (iv) the WTRU and the AS/AF.

13. The WTRU of claim 10, wherein the processor is configured to further predict upcoming packet delays using a history of packet delay measurements to predict upcoming one or more one-way packet delays.

14. (canceled)

15. The WTRU of claim 10, wherein the message indicates the PDU session release based on a condition that the predicted upcoming one or more one-way packet delays inhibit a transmission of the training results within the specified time period.

16. The WTRU of claim 10, wherein the processor is configured to initiate the PDU session modification procedure on condition that the processor determines to increase resources to assist a transmission of the training results within the specified time period.

17. The WTRU of claim 10, wherein the processor is configured to initiate the PDU session modification procedure on condition that the processor determines to decrease resources when not needed to transmit the training results within the specified time period.

18. The WTRU of claim 10, wherein the processor is configured to further predict upcoming two-way packet delays between any of (i) the WTRU and a radio access network (RAN), (ii) the RAN and a core network (CN), (iii) the CN and an AS/AF, and (iv) the WTRU and the AS/AF.

19. (canceled)

20. The method of claim 1, wherein the message indicates that a PDU session release procedure or modification procedure should be initiated.

21. The method of claim 1, wherein the one-way packet delay measurements are received via a PDU session (a previously established PDU session).

22. The method of claim 1, wherein the specified time period is defined by the WTRU's prediction of the one-way packet's one way time delay.

24. The WTRU of claim 10, wherein the message indicates that a PDU session release procedure or modification procedure should be initiated.

25. The WTRU of claim 10, wherein the one-way packet delay measurements are received via a PDU session (a previously established PDU session).

26. The WTRU of claim 10, wherein the specified time period is defined by the WTRU's prediction of the one-way packet's one way time delay.
